(19) United States
(12) Patent Application Publication
(10) Pub. No.: US 2020/0116124 A1
(43) Pub. Date: Apr. 16, 2020

(54) Wind Turbine Belt Drive Pitch Control

(71) Applicant: Gates Corporation, Denver, CO (US)

(72) Inventor: Jing Yuan, Rochester Hills, MI (US)

(21) Appl. No.: 16/158,965

(22) Filed: Oct. 12, 2018

(51) Int. Cl. F03D 7/02; F03D 15/10; F03D 80/80

(52) U.S. Cl. CPC F03D 7/0224; F05B 2260/79; F03D 80/88; F03D 15/10

(57) ABSTRACT

A blade pitch drive comprising a driver sprocket, a driven sprocket, a toothed belt trained between the driver sprocket and driven sprocket, the toothed belt having a free span between the driver sprocket and driven sprocket, the free span having an arcuate form when the free span is in a slack condition, the toothed belt having a second span between the driver sprocket and driven sprocket in a tight condition when the free span is in a slack condition, and the free span operable as the second span and the second span operable as the free span according to an operating direction of the drive.

### FIELD OF THE INVENTION

The invention relates to a wind turbine belt drive pitch control comprising a toothed belt having a free span between a driver sprocket and a driven sprocket, the free span having an arcuate form when the free span is in a slack condition.

### BACKGROUND OF THE INVENTION

Wind turbines typically require active blade pitch control to cope with the wind speed variations. When the wind speed is low, blade pitch (angle of attack) can be increased or adjusted as needed to harvest the wind energy. On the other hand, as the wind speed increases the blade angle of attack can also be adjusted to avoid potential overspeed leading to structural damage to the blade and turbine.

Traditionally, blade pitch control is realized by a gear drive. The system generally comprises a drive motor, a gearbox and drive ring. A turbine blade is attached to each drive ring. Rotation of each drive ring adjusts the blade angle of attack (pitch). The blades are adjusted in unison.

Belt drives are also used to control blade pitch. The prior art systems comprise a belt which is held tightly in a preloaded condition by adjustable clamps on both open ends. A backside idler is used to route the belt around a driver sprocket to increase the wrap angle and to prevent the tooth jumping. However, use of a backside idler can adversely affect belt life.

Representative of the art is U.S. Pat. No. 9,541,173 which discloses a toothed belt drive with compression span comprising a first sprocket, a second sprocket, a toothed belt having a toothed belt length and trained between the first sprocket and the second sprocket, a first linear guide member in cooperative relation to and disposed a predetermined distance (B) from the toothed belt, a second linear guide member in cooperative relation to and disposed a predetermined distance (B) from the toothed belt, and the toothed belt length greater than a drive length such that the toothed belt forms a free-standing arcuate span between the first sprocket and the second sprocket on a toothed belt compression span.

What is needed is a wind turbine belt drive pitch control comprising a toothed belt having a free span between a driver sprocket and a driven sprocket, the free span having an arcuate form when the free span is in a slack condition. The instant invention meets this need.

### SUMMARY OF THE INVENTION

An aspect of the invention is to provide a wind turbine belt drive pitch control comprising a toothed belt having a free span between a driver sprocket and a driven sprocket, the free span having an arcuate form when the free span is in a slack condition.

Other aspects of the invention will be pointed out or made obvious by the following description of the invention and the accompanying drawings.

The invention comprises a blade pitch drive comprising a driver sprocket, a driven sprocket, a toothed belt trained between the driver sprocket and driven sprocket, the toothed belt having a free span between the driver sprocket and driven sprocket, the free span having an arcuate form when the free span is in a slack condition, the toothed belt having a second span between the driver sprocket and driven sprocket in a tight condition when the free span is in a slack condition, and the free span operable as the second span and the second span operable as the free span according to an operating direction of the drive.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a wind turbine blade pitch movement.

FIG. 2 is a wind turbine prior art blade pitch control mechanism.

FIG. 3 is a prior art blade pitch control mechanism.

FIG. 4 is a schematic of the inventive blade pitch control mechanism.

FIG. 5 is a schematic of the inventive blade pitch control mechanism moving in a first rotational direction.

FIG. 6 is a schematic of the inventive blade pitch control mechanism moving in a second rotational direction.

### DETAILED DESCRIPTION OF THE PREFERRED EMBODIMENT

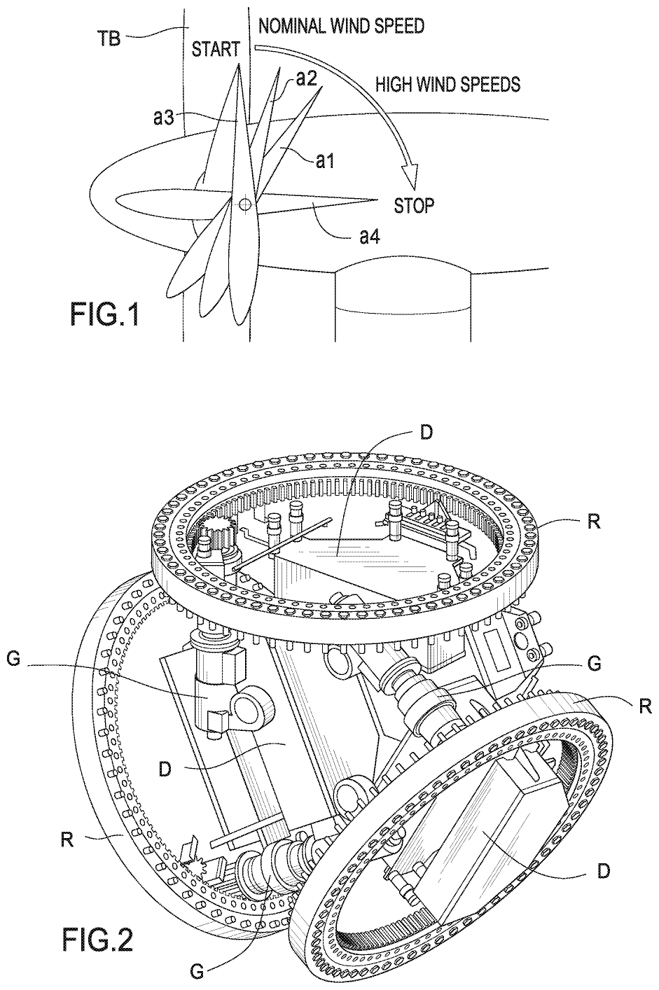

FIG. 1 is a wind turbine blade pitch movement. Wind turbines typically require active blade pitch control to cope with the wind speed variations. As shown in FIG. 1, when the wind speed is low, blade pitch (angle of attack) can be increased, from a1 to a3, to harvest the wind energy. On the other hand, as the wind speed increases the blade angle of attack can be reduced to avoid the potential overspeed structural damage to the blade and turbine, for example, from a1, a2, or a3 to a4. The blades are “feathered” in position a4 which stops rotation.

FIG. 2 is a wind turbine prior art blade pitch control mechanism. The pitch control mechanism is typically contained in the hub of a wind turbine prop.

Traditionally, blade pitch control is realized by a gear drive as shown in FIG. 2. The system generally comprises a drive motor (D), a gearbox (G) and drive ring (R). A turbine blade TB (FIG. 1) is attached to each drive ring (R). Rotation of each drive ring R adjusts the blade angle of attack (pitch). The blades are adjusted simultaneously.

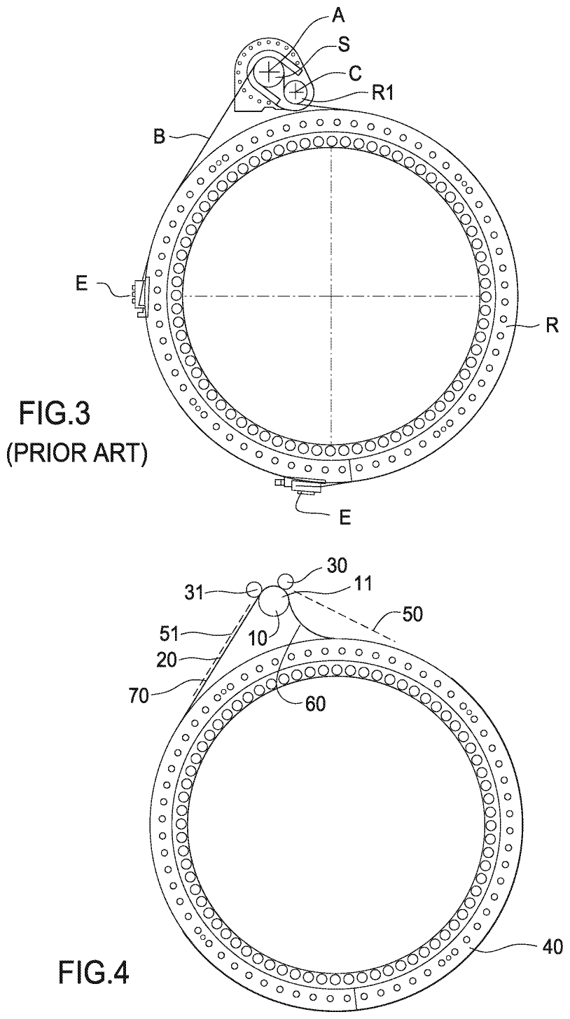

FIG. 3 is a prior art blade pitch control mechanism. FIG. 3 shows a prior art belt pitch drive layout that consists of drive motor A, open-end toothed belt B, guide backside idler C, drive ring R, and belt clamps E. Clamps E attach the ends of belt B to drive ring R.

An advantage of a belt drive over a gear drive is the ability to resist corrosion and a harsh environment especially for off-shore installations. However, belt failures in prior art systems tend to be caused by back bending of the belt B which can result in tensile cord damage. As known in the art, belts B comprise tensile cords for transmitting tensile loads.

Backside idler C is used to route belt B with sufficient wrap angle on small drive sprocket S to prevent tooth jump. As the drive rotates clockwise and counter clockwise during the pitch control adjustments, a slack span during the clockwise rotation will become the tight span during the counter clockwise rotation. The combination of high installed tension, back bending, and small sprocket radius are the main contributors to tensile cord failure. A secondary failure is tooth shear caused by the same section of the belt being engaged with the sprocket S and idler C during repeated back and forth pitch control adjustments.

FIG. 4 is a schematic of the inventive blade pitch control mechanism. The inventive compression belt drive solves two shortcomings of the prior art: (1) small radius back bending under the high tension, and (2) repeat usage on the same section of the belt. The belt drive comprises drive motor 10, belt 20, bearings 30 and 31, large drive ring 40, and two guards 50 and 51. Bearings 30, 31 are used instead of backside idler C because the bearing O.D. can be small in the inventive system. Bearings 30, 31 are placed at each point were the belt span is tangent to the driver sprocket 11 for a predetermined rotational direction. Bearings 30, 31 keep belt 20 engaged with sprocket 11 for either rotation direction. It also prevents the tight side from wrapping about sprocket 11. Belt 20 is an endless or continuous belt forming a loop. A turbine blade (not shown) is attached to each drive ring 40.

Belt guards 50, 51 are parallel to the belt tangent span with a small clearance to prevent constant contact with the belt. Belt 20 is deliberately selected to have a length that is longer than the drive length.

During installation the belt is buckled inward on the slack side 60 since guard 50 will prevent the belt from buckling outward. Slack side 60 has an arcuate shape when installed. The position of sprocket 11 with respect to drive ring 40 is selected to allow section 60 to have the arcuate form in the slack condition. Belt bending stiffness is selected to allow belt 20 to be compliable with the radius of sprocket 11.

Once installed, the belt is stable and engages the sprocket 11, which in turn increases the wrap angle of belt 20 about sprocket 11. Slack side 60 is a free span between sprocket 11 and drive ring 40 in that there is no idler or other sprocket in contact with the belt along the length of section 60.

Radius R2 of slack side section 60 is larger than radius R1 of a belt B engaging a prior art backside idler C, see FIG. 3. This configuration reduces back bending stresses in the belt.

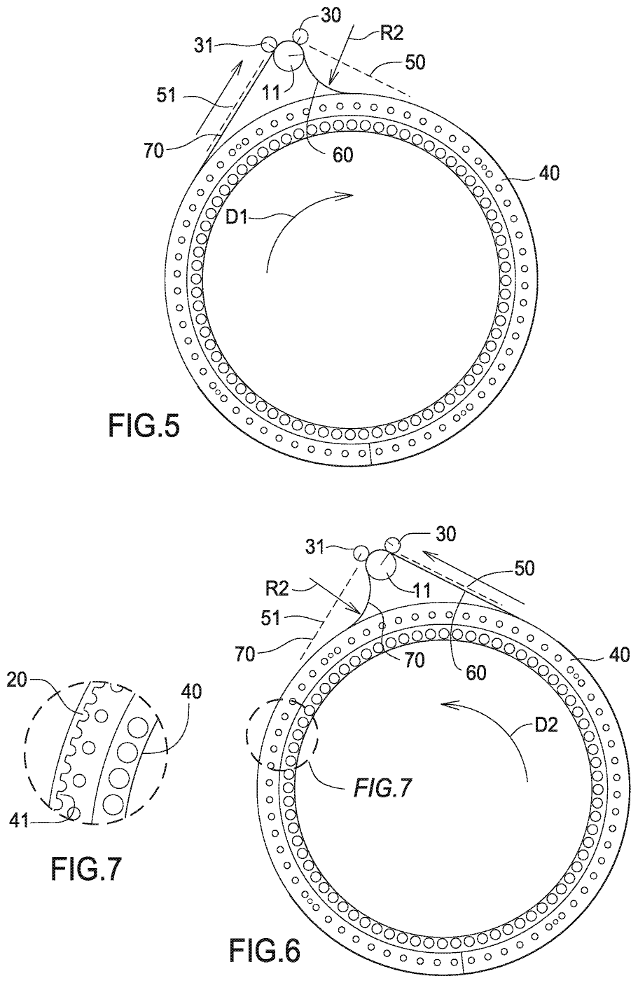

FIG. 5 is a schematic of the inventive blade pitch control mechanism moving in a first rotational direction. FIG. 5 shows the comparison of belt buckled position between slack span 60 and tight span 70. In operation drive ring 40 does not rotate while the driver sprocket 11 can rotate freely to take up the excess belt length from the slack side. The slack side and tight side reverse when the rotational direction is reversed. Namely, when the slack side span switches to the tight side span the buckled slack side span becomes the straight tight side span. This eliminates the need for a backside idler C on the tight side span.

The compression drive only has one belt arc section 70 that is tangent to both driver and driven, and the radius is significantly increased. The larger the bending radius on the belt results in reduced damage to the tensile cord. Further, the number of belt teeth is always larger than the number of drive ring sprocket teeth, so one drive ring revolution will never bring the belt back to the same location along the drive.

By way of example of not of limitation, an example system may comprise:
1. Belt 20 has 586 teeth.
2. Drive ring 40 has 552 teeth.
3. Blade pitch rotation range is 90 degrees so the drive ring engages 138 teeth thru the rotation range.
4. Belt length exceeds drive ring circumference by 34 teeth.
5. If the drive ring is periodically rotated by four 360° revolutions, this will advance the belt on the drive ring by 136 teeth, which means a new section of belt could be used for the following operating interval, thereby increasing belt operating life when compared to the prior art system.

FIG. 6 is a schematic of the inventive blade pitch control mechanism moving in a second rotational direction. FIG. 6 shows a section of the belt before one driven sprocket rotation and after one driven sprocket rotation. This strategy can be easily implemented in a way that after one prolong period, e.g. one year, the driven sprocket is advanced by one rotation, and belt is advanced to different location, consequently, the different belt section is used for the pitch control adjustment.

Slack side section 60 and tight side section 70 can change positions according to the operating direction of the drive. In drive direction D1 belt section 60 is the slack side. For drive direction D2 section 70 is the slack side. Guide 50 prevents section 60 from bowing outward when section 60 is the slack side. Guide 51 prevents section 70 from bowing outward when section 70 is the slack side.

The inventive drive provides the three advantages, namely; (1) it eliminates the tight high tension span under back bending around a backside idler C; (2) it increases the slack span back bending radius R2 significantly; and (3) it avoids repeated engagement of the same belt section with the driver sprocket 11.

A blade pitch drive comprising a driver sprocket, a driven sprocket, a toothed belt trained between the driver sprocket and driven sprocket, the toothed belt having a free span between the driver sprocket and driven sprocket, the free span having an arcuate form when the free span is in a slack condition, the toothed belt having a second span between the driver sprocket and driven sprocket in a tight condition when the free span is in a slack condition, and the free span operable as the second span and the second span operable as the free span according to an operating direction of the drive.

Although forms of the invention have been described herein, it will be obvious to those skilled in the art that variations may be made in the construction and relation of parts without departing from the spirit and scope of the invention described herein. Unless otherwise specifically noted, components depicted in the drawings are not drawn to scale. Further, it is not intended that any of the appended claims or claim elements invoke 35 U.S.C. § 112(f) unless the words “means for” or “step for” are explicitly used in the particular claim. The present disclosure should in no way be limiter to the exemplary embodiments or numerical dimensions illustrated in the drawings and described herein.

I claim:

1. A blade pitch drive comprising:
a driver sprocket;
a driven sprocket;
a toothed belt trained between the driver sprocket and driven sprocket;
the toothed belt having a free span between the driver sprocket and driven sprocket, the free span having an arcuate form when the free span is in a slack condition;
the toothed belt having a second span between the driver sprocket and driven sprocket in a tight condition when the free span is in a slack condition; and
the free span operable as the second span and the second span operable as the free span according to an operating direction of the drive.

2. The blade pitch drive as in claim 1, wherein the toothed belt is endless.

3. The blade pitch drive as in claim 1 further comprising a guide to control a free span projection direction.

4. The blade pitch drive as in claim 1 further comprising a second guide.

5. The blade pitch drive as in claim 1 further comprising a first bearing located adjacent to the driver sprocket where the toothed belt is tangent to the driver sprocket for a first operating direction.

6. The blade pitch drive as in claim 5 further comprising a second bearing located adjacent to the driver sprocket where the toothed belt is tangent to the driver sprocket for a second operating direction.

7. A blade pitch drive comprising:
a driver sprocket;
a driven sprocket;
a toothed belt trained between the driver sprocket and driven sprocket;
the toothed belt having a free span between the driver sprocket and driven sprocket, the free span having an arcuate form when the free span is in a slack condition;
the toothed belt having a second span between the driver sprocket and driven sprocket in a tight condition when the free span is in a slack condition;
the free span operable as the second span and the second span operable as the free span according to an operating direction of the drive;
a first bearing located adjacent to the driver sprocket where the toothed belt is tangent to the driver sprocket for a first operating direction; and
a second bearing located adjacent to the driver sprocket where the toothed belt is tangent to the driver sprocket for a second operating direction.

8. The blade pitch drive as in claim 7, wherein the toothed belt is endless.

9. The blade pitch drive as in claim 7 further comprising a guide to control a free span projection direction.

10. The blade pitch drive as in claim 9 further comprising a second guide.

11. A blade pitch drive comprising:
a driver sprocket;
a driven sprocket;
a toothed belt trained between the driver sprocket and driven sprocket;
the toothed belt having a free span between the driver sprocket and driven sprocket, the free span having an arcuate form when the free span is in a slack condition;
a guide to control a free span projection direction;
the toothed belt having a second span between the driver sprocket and driven sprocket in a tight condition when the free span is in a slack condition;
the free span operable as the second span and the second span operable as the free span according to an operating direction of the drive;
a first bearing located adjacent to the driver sprocket where the toothed belt is tangent to the driver sprocket for a first operating direction; and
a second bearing located adjacent to the driver sprocket where the toothed belt is tangent to the driver sprocket for a second operating direction.
